(19) United States
(12) Patent Application Publication
(10) Pub. No.: US 2015/0176973 A1
(43) Pub. Date: Jun. 25, 2015

(54) A DUAL INTERFEROMETER SYSTEM WITH A SHORT REFERENCE FLAT DISTANCE FOR WAFER SHAPE AND THICKNESS VARIATION MEASUREMENT

(71) Applicants: Shouhong Tang, Santa Clara, CA (US); Andrew An Zeng, Fremont, CA (US); Chunhai Wang, Pleasanton, CA (US); Fuu-Ren Tsai, Milpitas, CA (US); Frederick Arnold Goodman, Oakland, CA (US); Chunsheng Huang, San Jose, CA (US); Yi Zhang, Sunnyvale, CA (US)

(72) Inventors: Shouhong Tang, Santa Clara, CA (US); Andrew An Zeng, Fremont, CA (US); Chunhai Wang, Pleasanton, CA (US); Fuu-Ren Tsai, Milpitas, CA (US); Frederick Arnold Goodman, Oakland, CA (US); Chunsheng Huang, San Jose, CA (US); Yi Zhang, Sunnyvale, CA (US)

(73) Assignee: KLA-TENCOR CORPORATION, Milpitas, CA (US)

(21) Appl. No.: 13/316,223

(22) Filed: Dec. 9, 2011

(51) Int. Cl. G01B 11/06; G01B 9/02

(52) U.S. Cl. CPC G01B 11/06; G01B 9/02027; G01B 9/02049

(57) ABSTRACT

An interferometer system is disclosed. The interferometer system includes two spaced apart reference flats having corresponding reference surfaces forming a cavity therebetween for placement of a polished opaque plate. The surfaces of the plate are approximately 2.5 millimeters or less from the corresponding reference surfaces when the plate is placed in the cavity. The interferometer system also includes two interferometer devices located on diametrically opposite sides of the cavity to map the surfaces of the plate. A light source is optically coupled to the interferometer devices. The light source includes an illuminator configured for producing light of multiple wavelengths and an optical amplitude modulator configured for stabilizing power of the light produced by the illuminator. The interferometer system further includes two interferogram detectors, and at least one computer coupled to receive the outputs of the interferogram detectors for determining thickness variations of the plate.

### TECHNICAL FIELD

The disclosure generally relates to the field of measuring technology, particularly to a method and apparatus for measuring the shape and thickness variation of a wafer.

### BACKGROUND

Thin polished plates such as silicon wafers and the like are a very important part of modern technology. A wafer, for instance, refers to a thin slice of semiconductor material used in the fabrication of integrated circuits and other devices. Other examples of thin polished plates may include magnetic disc substrates, gauge blocks and the like. While the technique described here refers mainly to wafers, it is to be understood that the technique also is applicable to other types of polished plates as well.

Generally, certain requirements may be established for the flatness and thickness uniformity of the wafers. There exist a variety of techniques to address the measurement of shape and thickness variation of wafers. One such technique is disclosed in U.S. Pat. No. 6,847,458, which is capable of measuring the surface height on both sides and thickness variation of a wafer. It combines two phase-shifting Fizeau interferometers to simultaneously obtain two single-sided distance map between each side of a wafer and corresponding reference flats, and computes thickness variation and shape of the wafer from the data and calibrated distance map between two reference flats. However, it is noted that sensitivity to wafer vibration in such a measurement system need to be further improved. Other shortcomings of this technique may include the lack of the ability to provide absolute wafer thickness information, and that the system is physically large for measuring larger wafers.

Another technique is disclosed in U.S. Pat. No. 7,009,696, which is also able to measure the surface height on both sides and thickness variation of a wafer. It combines two grazing incidence interferometers, simultaneously obtains front and backside topography data and stitches multiple measurements of portions of the wafer together to form full wafer topography data maps. The thickness variation and shape of the wafer from may then be computed based on the topography data maps. However, this measurement system has a long, non-common optical path length between object and reference which makes it susceptible to air temperature gradients (air turbulences). It also lacks the ability to provide absolute wafer thickness information. In addition, the damping arrangement utilized in this system does not cover the entire surface area of the wafer and is applied only on one side of the wafer.

A further technique is disclosed in U.S. patent application Ser. No. 12/388,487, the disclosure of which is incorporated herein by reference in its entirety, improves the vibration damping of the system disclosed in the U.S. Pat. No. 6,847,458 (described above). However, the measurement accuracy and precision may still be further improved. In addition, the optical design of the system results in a larger physical profile, which may not be desirable in various locations such as manufacturing facilities, labs or the like. Furthermore, the system does not combine an active and passive vibration isolation with the small gap air damping design so that floor vibration will affect the system performance.

Therein lies a need for a method and apparatus for measuring the shape and thickness variation of a wafer, without the aforementioned shortcomings.

### SUMMARY

The present disclosure is directed to an interferometer system. The interferometer system includes first and second spaced apart reference flats having corresponding first and second parallel reference surfaces forming a cavity therebetween for placement of a polished opaque plate. The first and second surfaces of the polished opaque plate are approximately 2.5 millimeters or less from the corresponding first and second reference surfaces of the first and second reference flats when the polished opaque plate is placed in the cavity. The interferometer system also includes first and second interferometer devices located on diametrically opposite sides of the cavity to map the opposite first and second surfaces of the polished opaque plate. A light source is optically coupled to the first and second interferometer devices. The light source includes an illuminator configured for producing light of multiple wavelengths and an optical amplitude modulator configured for stabilizing power of the light produced by the illuminator. The interferometer system further includes first and second interferogram detectors, and at least one computer coupled to receive the outputs of the first and second interferogram detectors for determining thickness variations of the plate.

Furthermore, the interferometer system may include a vibration control unit configured for providing active vibration isolation for at least the first and second reference flats, the first and second interferometer devices and the first and second interferogram detectors. The interferometer system may also include a temperature controlled enclosure configured for providing a thermally stable environment for at least the first and second reference flats, the first and second interferometer devices and the first and second interferogram detectors. The interferometer system may further include a wafer handling mechanism configured for handling and transferring the polished opaque plate in and out of the cavity. In addition, the optical paths in the interferometer devices may be folded to reduce the physical size of the interferometer devices.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 is a diagrammatic representation of an interferometer system for measuring shape and thickness variation of a wafer according to an embodiment of the present invention; and

FIG. 2 is a flow diagram illustrating a method for measuring the shape and thickness variation of a wafer utilizing the interferometer system shown in FIG. 1.

### DETAILED DESCRIPTION

Reference will now be made in detail to the subject matter disclosed, which is illustrated in the accompanying drawings.

Silicon wafers are available in a variety of sizes. Semiconductor fabrication plants (also known as fabs) are defined by the size of wafers that they are tooled to produce. The size has gradually increased to improve throughput and reduce cost with the current standard considered to be 300 mm diameter. The next standard is projected to be 450 mm or even greater. It is noted that addressing the measurement of shape and thickness variation of such larger wafers is not a simple scale up tool of the existing measurement systems. As the size of the wafer increases, simply scaling up an existing tool makes the resulting tool more expensive (to produce and/or operate), physically larger, harder to transport and more sensitive to vibrations.

The present disclosure is directed to a method and apparatus for measuring a large size (e.g., greater than 300 mm diameter), thin opaque plate (e.g., a silicon wafer) for its shape, surface height on both sides and thickness variations. The apparatus in accordance with the present disclosure also utilizes an improved interferometric system for profiling both sides of a wafer simultaneously and computing the wafer thickness variation that is independent of the shape of a reference plate. Various other features of the method and apparatus in accordance with the present disclosure will be described in details.

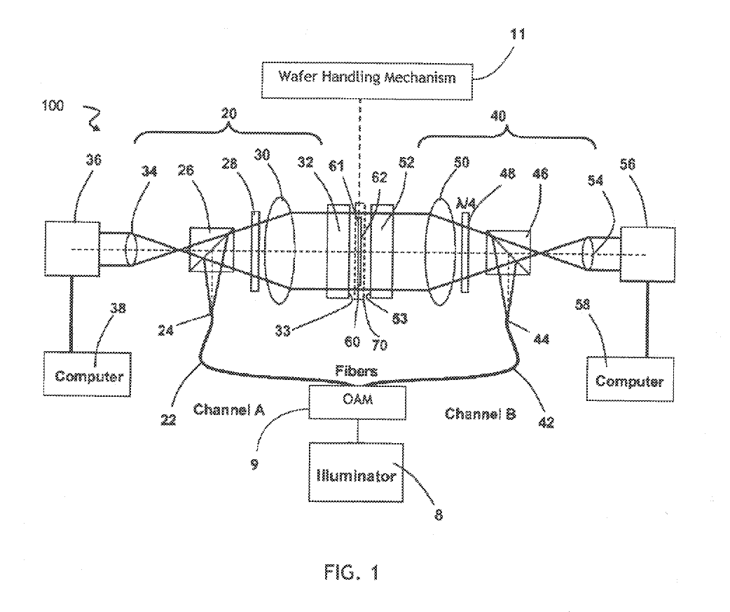

Referring to FIG. 1, a block diagram depicting the measurement system 100 in accordance with the present disclosure is shown. The measurement system 100 in accordance with the present disclosure utilizes two Fizeau interferometers similar to that disclosed in U.S. Pat. No. 6,847,458 (the disclosure of which is incorporated herein by reference in its entirety). However, the measurement system 100 in accordance with the present disclosure differs from that disclosed in U.S. Pat. No. 6,847,458 in various ways in order to achieve high precision and high accuracy measurements for larger wafers (e.g., 450 mm or greater).

As depicted in FIG. 1, the measurement system 100 is configured for measuring the shape and thickness of a wafer 60. The wafer 60 may be placed in a cavity in the center between two Fizeau interferometers 20 and 40. The reference flats 32 and 52 of the interferometers are placed very close to the wafer 60 in accordance with the present disclosure. In one embodiment, the distance between the reference flat surfaces 33 and 53 and the wafer surfaces 61 and 62 is less than 2.5 mm, respectively.

The measurement system 100 provides two light sources for Channel A and Channel B through fiber 22 and fiber 42 from a single illuminator 8 that generates a constant power output during its wavelength tuning. In one embodiment, the light source 24,44 provides light that passes through a quarter-wave plate 28,48 aligned at 45° to the polarization direction of light after it is reflected from the polarizing beam splitter 26,46. This beam then propagates to the lens 30,50, where it is collimated with a beam diameter larger than the wafer diameter.

The beam then goes through transmission flat 32,52, where the central part of the transmitted beam is reflected at the test surface 61,62 that forms an interferogram with the light beam reflected from the reference surface 33,53. The outer part of the transmitted beam travels on to the opposite reference flat 52,32, where it is reflected at the reference surface 53,33 that forms an annular shape interferogram with the light beam reflected from the reference surface 33,53. An interferogram detectors (e.g., an imaging device such as a camera or the like) 36,56 is utilized to record the interferograms and send the interferograms to a computer 38,58 for processing to produce the desired information such as the shape and the thickness variation of a wafer.

In one embodiment, the distance between the reference surfaces 33 and 53 and the measuring wafer surfaces 61 and 62 is approximately 1.8 mm, respectively; the wavelength of the light provided by the light sources 24 and 44 is approximately 639 nm; the diameter of each reference flat 32 and 52 is approximately 480 mm; and each imaging device 36 and 56 has a resolution of about 4 k by 4 k pixels. However, it is understood the configuration described above is merely exemplary. Various components of the measurement system 100 may be configured differently without depart from the spirit and scope of the present disclosure.

Reducing the distance between the reference flat surface 33,53 and the wafer surface 61,62 to less than 2.5 mm provides several advantages. For instance, the reduced distance damps down vibration that becomes much more serious due to the increased size of the wafer 60. In addition, the reduced distance enables the measurement system 100 to compute the absolute wafer thickness based on optical images obtained by the imaging system 36,56.

In addition to the reduced distance between the flat and wafer surfaces, the measurement system 100 in accordance with the present disclosure also folds the optical paths in a different way to reduce the physical dimensions of the measurement system 100. For instance, in order to minimize the ray-tracing error in Fizeau interferometer design, a predetermined optical distance (e.g., about 1 meter) may be required between the quarter-wave plate 28,48 and the lens 30,50. In one embodiment, in order to reduce the overall physical size of the measurement system 100, a plurality of mirrors may be positioned between the quarter-wave plate 28,48 and the lens 30,50 and may be utilized to fold the optical path between the quarter-wave plate 28,48 and the lens 30,50. Utilizing such a folded optical path reduces the physical dimension of the measurement system 100 while still maintaining the optical distance between the quarter-wave plate 28,48 and the lens 30,50.

While placing the reference flat surfaces close to the measurement wafer passively damp down wafer vibrations, it is contemplated that the measurement system 100 may be further equipped with an active vibration isolation mechanism to minimize the system sensitivity to noises and vibration. For instance, the metrology unit that encloses both Fizeau interferometers 20 and 40 may be placed on a vibration control unit that have both active and passive damping capability to isolate the entire metrology unit from seismic and acoustic vibration. In this manner, the vibration isolation for the measurement system 100 is enhanced by integrating active isolations with passive isolations. Such a configuration may be appreciated since it does not require the user to provide an external isolated platform to support the measurement system 100.

It is also contemplated that the measurement system 100 may be placed in a temperature controlled enclosure. Such an enclosure is capable of providing a thermally stable environment for the measurement system 100 to operate within, enhancing the accuracy of the measurements obtained thereof. For instance, in a particular embodiment, the temperature in the thermally stable environment for the measurement system 100 may range between ±0.1° C.

It is further contemplated that an automated wafer handling mechanism 11 may be employed for handling and transferring the wafer 60 in and out of the cavity between the transmission flats 32 and 52. Such an automated wafer handling mechanism 11 may be realized in the form of a single or multi-deck mechanical arm or the like, which may be fully automated for rapidly and precisely handling wafers without human interaction and/or exposures to potential contaminants.

Furthermore, it is understood that as the cavity between the transmission flats 32 and 52 becomes smaller (i.e., the distances between the reference flat surface 33,53 and the wafer surface 61,62 become smaller), the wavelength tuning range of the illuminator 8 (i.e., a tunable laser source) need to be increased accordingly in order to achieve the desired phase-shifting between adjacent frames during data acquisition. However, increasing the tuning range of the illuminator 8 inherently results in a large light power variation that may deteriorate the measurement result. In one embodiment, an external Optical Amplitude Modulator (OAM) 9 is positioned at the output of the illuminator 8 to modify the light power as the light goes through. In this manner, the OAM 9 stabilizes the output of the illuminator 8, and therefore minimizes the light power variation due to the increased wavelength tuning range.

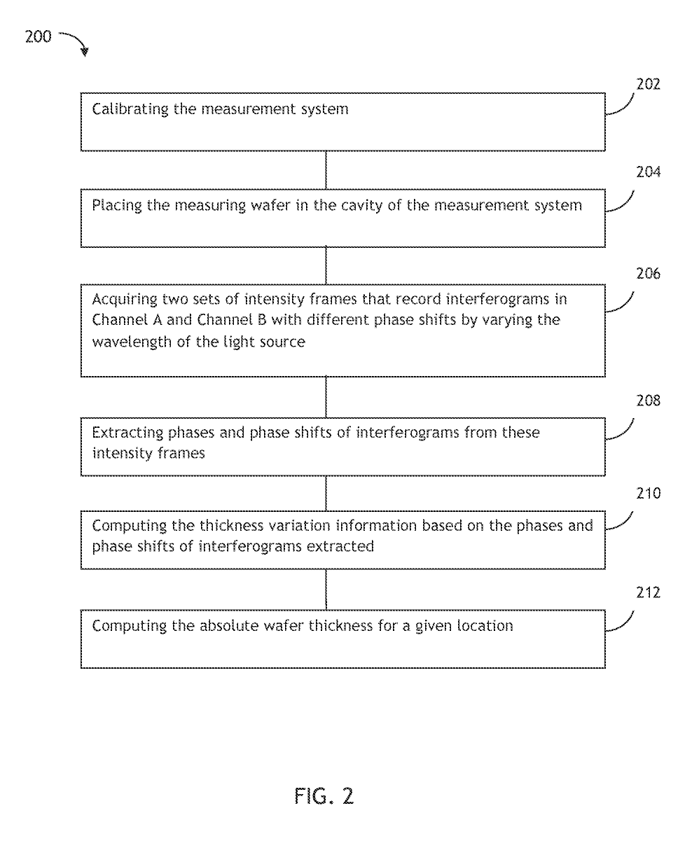

Referring now to FIG. 2, a method 200 for measuring the shape and thickness variation of a wafer utilizing the measurement system 100 described above is shown. Step 202 may first calibrate the measurement system. For instance, the phase shifting speed of the interferograms in the two interferometer channels may be calibrated. The phase shifting speed may be calibrated by placing a polished opaque plate in the cavity between the reference flats 32 and 52. Alternatively, this calibration may be conducted by the cavity itself (without the polished opaque plate). Upon completion of the phase shift calibration, or when the phase shift between any adjacent frames is within ±1 degree or less of its expected value such as 90 degrees for the phase shift between any adjacent frames, the cavity characteristics of the reference flats 32 and 52 may then be calibrated with the cavity itself.

Once the measurement system is calibrated, the wafer 60 that is to be measured may be placed in the cavity in step 204. The wafer 60 may be placed in between the two Fizeau interferometers 20 and 40 (more specifically, between the reference flats 32 and 52). A holding container may be utilized to removably secure the wafer 60 when the wafer 60 is placed in the cavity. The holding container may be configured in a manner such that both wafer sides 61 and 62 are minimally obscured by the holding container. While it may be beneficial to place the wafer 60 in the center of the cavity (i.e., the distance between the reference surface 33 and 61 is substantially equal to the distance between the reference surface 53 and 62), such a placement is not required. It is contemplated that if the wafer 60 is placed in an off-center position and/or rotated from its expected position inside the cavity, image processing algorithms associated with the imaging systems 36 and 56 may be utilized to compensate for such an off-center placement and/or rotation.

Step 206 may then acquire two sets of intensity frames that record interferograms in Channel A and Channel B with different phase shifts by varying the wavelength of the light source 8. Step 208 may extract phases and phase shifts of interferograms from these intensity frames, and step 210 may compute the shape and thickness information based on the phases and phase shifts of interferograms extracted in step 208. In one embodiment, the shape and thickness information may be computed in a manner similar to that disclosed in U.S. Pat. No. 6,847,458. For instance, let A denote the phase of interferogram formed by reference flat 32 and wafer surface 61, let B denote the phase of interferogram formed by the reference flat 53 and wafer surface 62, and let C denote the phase of interferogram formed by the cavity of two reference flats 32 and 53. Thus A provides information regarding the height of the wafer surface 61, B provides information regarding the height of the wafer surface 62, and C−(A+B) provides information regarding the thickness variation of the wafer 60.

It is contemplated that steps 206 through 210 may be carried out multiple times in order to increase the precision and accuracy of the measurement result. The number of iterations to be performed may be customized to meet requirements demanded by different users and/or for different types of wafers.

The phase shifts of interferograms extracted in step 208 also allows the absolute wafer thickness to be calculated in step 212. In one embodiment, the absolute thickness of a particular location of the wafer 60 is computed from the amount of phase shift per known wavelength change. For instance, let A denote the phase shift of interferogram formed by reference flat 32 and wafer surface 61 during the data acquisition, let B denote the phase shift of interferogram formed by the reference flat 53 and wafer surface 62 during the data acquisition, and let C denote the phase shift of interferogram formed by the cavity of two reference flats 32 and 53 during the data acquisition. Thus A provides the absolute distance between reference flat 32 and wafer surface 61 at that particular location, B provides the absolute distance between reference flat 52 and wafer surface 62 at that particular location, C provides the absolute distance between reference flat 33 and 53, and C−(A+B) gives the absolute wafer thickness for that particular location.

It is understood, however, that step 212 is optional. The absolute thickness of a particular location of the wafer 60 may be computed utilizing other techniques not particularly based on phase shift per known wavelength change as described above.

It is contemplated that the method and apparatus in accordance with the present disclosure may be utilized for measuring large wafers (e.g., 450 mm or larger) without merely scale up an existing system. An improved interferometric system is provided for profiling both sides of a wafer simultaneously and computing the wafer thickness variation that is independent of the shape of interferometric reference plates. The apparatus in accordance with the present disclosure also employs a light source that keeps a constant power output during its long-range, without the need for mode-hop wavelength tuning. The external Optical Amplitude Modulator utilized to stabilize the output of the light source minimizes the light power variation and increases the measurement precision and accuracy.

The method and apparatus in accordance with the present disclosure provides several advantages over existing measurement techniques. For instance, folding the optical path and minimizing the non-common paths of interferometers reduces the physical size of the apparatus. In addition, reduced cavity distance with a constant power wavelength tuning minimizes measurement errors and improves wafer vibration damping. The reduced cavity distance also enables high precision phase shift extraction, making the measurement of the absolute thickness based on optical information possible as described above. Furthermore, the measurement system in accordance with the present disclosure may be enclosed in a thermally stable enclosure and/or equipped with an active vibration isolation mechanism to further improve its measurement repeatability. A fully automated wafer handling mechanism may also be employed for precisely handling wafers without human interaction and/or exposures to potential contaminants.

It is to be understood that the present disclosure may be implemented in forms of a software/firmware package. Such a package may be a computer program product which employs a computer-readable storage medium/device including stored computer code which is used to program a computer to perform the disclosed function and process of the present disclosure. The computer-readable medium may include, but is not limited to, any type of conventional floppy disk, optical disk, CD-ROM, magnetic disk, hard disk drive, magneto-optical disk, ROM, RAM, EPROM, EEPROM, magnetic or optical card, or any other suitable media for storing electronic instructions.

The methods disclosed may be implemented as sets of instructions, through a single production device, and/or through multiple production devices. Further, it is understood that the specific order or hierarchy of steps in the methods disclosed are examples of exemplary approaches. Based upon design preferences, it is understood that the specific order or hierarchy of steps in the method can be rearranged while remaining within the scope and spirit of the disclosure. The accompanying method claims present elements of the various steps in a sample order, and are not necessarily meant to be limited to the specific order or hierarchy presented.

It is believed that the system and method of the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory.

1. An interferometer system, comprising:
first and second interferometer devices, the first and second interferometer devices including first and second spaced apart reference flats having corresponding first and second parallel reference surfaces forming a cavity therebetween for placement of a polished opaque plate, wherein the first and second reference surfaces of the first and second reference flats are positioned approximately 5 millimeters or less from each other uniformly throughout the parallel surfaces, allowing first and second surfaces of the polished opaque plate to be approximately 2.5 millimeters or less from the corresponding first and second reference surfaces of the first and second reference flats when the polished opaque plate is placed in the cavity, and wherein the first and second interferometer devices are located on diametrically opposite sides of the cavity to map the opposite first and second surfaces of the polished opaque plate;
a mechanical arm configured for handling and transferring the polished opaque plate in and out of the cavity;
a light source optically coupled to the first and second interferometer devices, the light source comprising an illuminator configured for producing light of multiple wavelengths and an optical amplitude modulator configured for stabilizing power of the light produced by the illuminator;
first and second interferogram detectors; and
at least one computer coupled to receive the outputs of the first and second interferogram detectors for determining thickness variations of the plate.

2. The interferometer system of claim 1, wherein the first and second interferometer devices are Fizeau interferometers.

3. The interferometer system of claim 2, wherein an optical path between a quarter-wave plate and a lens of each Fizeau interferometer is folded to reduce the physical size of the Fizeau interferometer.

4. The interferometer system of claim 3, wherein the optical path is folded utilizing a plurality of mirrors.

5. The interferometer system of claim 1, further comprising a vibration control unit configured for providing active vibration isolation for at least the first and second reference flats, the first and second interferometer devices and the first and second interferogram detectors.

6. The interferometer system of claim 1, further comprising a temperature controlled enclosure configured for providing a thermally stable environment for at least the first and second reference flats, the first and second interferometer devices and the first and second interferogram detectors.

7. The interferometer system of claim 6, wherein the thermally stable environment is maintained in a range between ±0.1° C.

8. The interferometer system of claim 1, wherein the first and second reference flats each has a diameter of approximately 480 mm.

9. An interferometer system, comprising:
first and second interferometer devices, the first and second interferometer devices including first and second spaced apart reference flats having corresponding first and second parallel reference surfaces forming a cavity therebetween for placement of a polished opaque plate, wherein the first and second reference surfaces of the first and second reference flats are positioned approximately 5 millimeters or less from each other uniformly throughout the parallel surfaces, allowing first and second surfaces of the polished opaque plate to be approximately 2.5 millimeters or less from the corresponding first and second reference surfaces of the first and second reference flats when the polished opaque plate is placed in the cavity, and wherein the first and second interferometer devices are located on diametrically opposite sides of the cavity to map the opposite first and second surfaces of the polished opaque plate;
a light source optically coupled to the first and second interferometer devices, the light source comprising an illuminator configured for producing light of multiple wavelengths and an optical amplitude modulator configured for stabilizing power of the light produced by the illuminator;
first and second interferogram detectors;
at least one computer coupled to receive the outputs of the first and second interferogram detectors for determining thickness variations of the plate; and
a temperature controlled enclosure configured for providing a thermally stable environment for at least the first and second reference flats, the first and second interferometer devices and the first and second interferogram detectors.

10. The interferometer system of claim 9, wherein the first and second interferometer devices are Fizeau interferometers.

11. The interferometer system of claim 10, wherein an optical path between a quarter-wave plate and a lens of each Fizeau interferometer is folded to reduce the physical size of the Fizeau interferometer.

12. The interferometer system of claim 11, wherein the optical path is folded utilizing a plurality of mirrors.

13. The interferometer system of claim 9, wherein the thermally stable environment is maintained in a range between ±0.1° C.

14. The interferometer system of claim 9, further comprising a mechanical arm configured for handling and transferring the polished opaque plate in and out of the cavity.

15. The interferometer system of claim 9, wherein the first and second reference flats each has a diameter of approximately 480 mm.

16. An apparatus for measuring the thickness variation and shape of a polished opaque plate, the apparatus comprising:
first and second interferometer devices, the first and second interferometer devices including first and second spaced apart reference flats having corresponding first and second parallel reference surfaces forming a cavity therebetween for placement of the polished opaque plate, wherein the first and second reference surfaces of the first and second reference flats are positioned approximately 5 millimeters or less from each other uniformly throughout the parallel surfaces, allowing first and second surfaces of the polished opaque plate to be approximately 2.5 millimeters or less from the corresponding first and second reference surfaces of the first and second reference flats when placed within the cavity, and wherein the first and second interferometer devices are located on diametrically opposite sides of the cavity to map the opposite first and second surfaces of the polished opaque plate;
a light source optically coupled to the first and second interferometer devices, the light source comprising an illuminator configured for producing light of multiple wavelengths and an optical amplitude modulator configured for stabilizing power of the light produced by the illuminator;
first and second interferogram detectors;
at least one computer coupled to receive the outputs of the first and second interferogram detectors for determining thickness variations of the plate;
a temperature controlled enclosure configured for providing a thermally stable environment for at least the first and second reference flats, the first and second interferometer devices and the first and second interferogram detectors; and
a mechanical arm configured for handling and transferring the polished opaque plate in and out of the cavity.

17. The apparatus of claim 16, wherein the first and second interferometer devices are Fizeau interferometers.

18. The apparatus of claim 17, wherein an optical path between a quarter-wave plate and a lens of each Fizeau interferometer is folded to reduce the physical size of the Fizeau interferometer.

19. The apparatus of claim 18, wherein the optical path is folded utilizing a plurality of mirrors.

20. The apparatus of claim 16, wherein the first and second reference flats each has a diameter of approximately 480 mm, and wherein the first and second reference surfaces of the first and second reference flats are positioned approximately 3.6 millimeters from each other uniformly throughout the parallel surfaces, allowing the first and second surfaces of the polished opaque plate to be approximately 1.8 millimeters from the corresponding first and second reference surfaces of the first and second reference flats when the polished opaque plate is placed in the cavity.
